(19) United States
(12) Patent Application Publication
(10) Pub. No.: US 2003/0142875 A1
(43) Pub. Date: Jul. 31, 2003

(54) Quality priority

(76) Inventor: Kenbe D. Goertzen, Topeka, KS (US)

Correspondence Address: BROMBERG & SUNSTEIN LLP, 125 SUMMER STREET, BOSTON, MA, 02110-1618, US

(21) Appl. No.: 10/352,379

(22) Filed: Jan. 27, 2003

Related U.S. Application Data
(63) Continuation-in-part of application No. 09/498,924, filed on Feb. 4, 2000, now Pat. No. 6,532,308.
(60) Provisional application No. 60/351,463, filed on Jan. 25, 2002.
(60) Provisional application No. 60/356,388, filed on Feb. 12, 2002.
(60) Provisional application No. 60/118,554, filed on Feb. 4, 1999.

(51) Int. Cl. G06K 9/36

(52) U.S. Cl. 382/240

(57) ABSTRACT

A system, method, and electronic chip for compressing a digital data signal while maintaining a quality level is disclosed. A signal is received that is representative of a quality level. The signal may be received into a computer system or into an electronic chip, such as an application specific integrated circuit or an electronic chip operating with a computer system. A digital data signal, which may be a digital image stream is decorrelated based in part on the received quality level. The decorrelated digital data signal is quantified according to frequency so as to provide equal resolution across all frequencies. The quantified digital data signal is then entropy encoded. The digital data signal is thereby compressed. Upon decompression, the uncompressed data maintains the desired quality level over all values. If the values are color components within a digital image stream, the color components will have the desired S/N ratio.

### CROSS REFERENCE TO RELATED APPLICATIONS

The following application claims priority from U.S. Provisional Patent Application No. 60/351,463 filed on Jan. 25, 2002 entitled Digital Mastering Codec ASIC and bearing attorney docket no. 2418/130, the application also claims priority from U.S. Provisional Patent Application No. 60/356,388, entitled Codec filed on Feb. 12, 2002 bearing attorney docket no. 2418/131, from U.S. patent application Ser. No. 09/498,924 filed on Feb. 4, 2000 entitled Quality Priority Image Storage and Communication which itself has a priority claim to U.S. Provisional Patent Application No. 60/118,554 entitled Quality Priority Image Storage and Communication, all of which are incorporated by reference herein in their entirety.

### TECHNICAL FIELD AND BACKGROUND ART

The present invention relates to digital video and more specifically to guaranteed quality levels for compressed video data.

Sampling theory and information theory are well known to those skilled in the art and have been written about in such texts as “Introduction to Shannon Sampling and Interpolation Theory”, by Robert J. Marks II and “The Mathematical Theory of Communication” by Claude E. Shannon and Warren Weaver. Both texts are incorporated by reference herein in their entirety.

A sample is that which is sensed by a sensor in the conversion process from an analog signal into a digital representation. The sample domain characterizes a signal which is sampled relative to some sample metric. For example, an audio signal may be sampled relative to time, whereas images are sampled relative to position. For all sampled data, the Nyquist frequency and the sample resolution determine the absolute limit of the information contained within the sample. The typical information content of a sample set is, in general, much lower than the data used to represent a sample due to noise.

Noise is introduced into a sample in any one of a plurality of ways. The quantization process adds noise to a sample since a digital representation has only finite steps and cannot exactly represent the originating analog signal. Additionally, noise is often introduced into the signal path through the sensor or transmission medium. These constraints detract from the information content of the sampled signal.

It is known in the prior art to compress data and more specifically to compress data which is representative of video images. In the prior art there have been two types of data compression for video.

The first type of compression is a loss-based system which attempts to maximize compression so that the data size is minimized at the expense of the quality of the data. The focus of such systems is to minimize the data size for storage purposes or for decreasing the data rate of a video stream of information. These systems, such as, MPEG do not provide a quantative method for judging the quality of the entire image upon decompression, but rather base the quality of the image solely on human perception. Further, the MPEG standard relies on a block based DCT for transformation and therefore the entire image has differing degrees of quality. As a result, the image resolution can not be guaranteed across all frequencies of the input video sequence.

The second type of compression is loss-less compression. In such a system no data is lost upon decompression. Loss-less compression systems, such as PKZIP, maintain all of the data upon decompression, but this ability comes at the expense of compression ratios since noise associated with the digital data is not removed. Loss-less systems can compress data by only a few times their original size.

Therefore, it would be advantageous to have a loss-based compression system which allowed for the compression of an input signal while preserving the quality level over all spatial frequencies. Further it would be advantageous to have a loss-based compression system that provided multi-dimensional quality preservation including the temporal domain.

### SUMMARY OF THE INVENTION

A system, method, and electronic chip for compressing a digital data signal while maintaining a quality level is disclosed. A signal is received that is representative of a quality level. The signal may be received into a computer system or into an electronic chip, such as an application specific integrated circuit or an electronic chip operating with a computer system. A digital data signal, which may be a digital image stream is decorrelated based in part on the received quality level. The decorrelated digital data signal is quantified according to frequency so as to provide equal resolution across all frequencies. The quantified digital data signal is then entropy encoded. The digital data signal is thereby compressed. Upon decompression, the uncompressed data maintains the desired quality level over all values. If the values are color components within a digital image stream, the color components will have the desired S/N ratio. In order to perform, quality priority encoding, as described, the number of transforms to be performed on the digital data signal is first calculated. The number of transforms is based upon the desired resolution, and also the original digital data-values. For example, if the digital data is 16 bits in length, the resolution may be stored at a level which is less than 16 bits of resolution. Based upon this information, the number of transforms is determined. Such information can be determined prior to performing the methodology and pre-programmed in computer-readable/processor-readable code. The number of transforms that are performed on the digital data is such that the digital data is decorrelated while still maintaining the desired quality level. The decorrelation may be accomplished by either spatial or temporal transforms. In one embodiment, the transforms are wavelet-based transforms. The methodology may include temporal transform coding, such that the digital data signal is decorrelated according to time. In such an embodiment, the quantization process includes quantifying the digital data to maintain a desired resolution across all frequencies. During the quantization process, the values are quantified so as to follow a transfer function. In one embodiment, the transfer function is followed according to sub-band. In other embodiments, the transfer function may be empirically determined. For example, the transfer function for temporal quantization may be empirically determined according to human perception. The transfer function may be a sampling theory curve represented in an information domain. In the information domain, frequency is graphed versus resolution which may be represented in bits of information or in terms of a signal to noise ratio. The signal to noise ratio is determined with respect to the Nyquist frequency for most systems, but the S/N ratio varies based upon frequency. As such, more resolution is needed at the lower frequencies than at the higher frequencies. Such that a system which has 8 bits of resolution at Nyquist will need to be represented with more bits of resolution in the lower frequencies in order to maintain 8 bits of resolution.

In certain embodiments, the quantization is kept at or above a sampling theory curve. In other embodiments, the amount that the quantization is kept above the sampling theory curve is dependant in part on the exactness of the transforms.

It should be understood that such encoding techniques are independent of the input data. The input data may represent 2-D video images, audio data, 3-D spatial images, or 3-D spatial images taken over time, such that the data is 4 dimensional.

The methodology may be embodied in an electronic chip, such as an application specific integrated circuit (ASIC). The ASIC may be simply a quality priority module. The quality priority module may include circuitry for quantizing the digital input data such that the values maintain a defined quality level over all frequencies. The ASIC may include a transform module which transforms the digital data into a frequency divided representation. The transform module may be programmable and programmed to perform wavelet-based transforms. The ASIC may be designed such that the wavelet-based transforms can be recursively performed. The transform module may contain circuitry that allows for the performance of spatial based transforms, temporal-based transforms or spatial and temporal-based transforms.

### BRIEF DESCRIPTION OF THE DRAWINGS

The foregoing features of the invention will be more readily understood by reference to the following detailed description, taken with reference to the accompanying drawings, in which:

FIG. 1 shows a compression system for removing non-information from a digital data signal while maintaining a defined quality level for the digital data.

FIG. 1A is a graph which shows a sampling theory curve.

FIG. 1B is a graph which shows multiple sampling theory curves for selected Nyquist frequency resolutions

FIG. 1C is a curve showing the guard band k.

FIG. 2 is a flow chart showing the compression process;

FIG. 3 is a graph showing a transform function exhibiting a bump due to non-orthogonality;

FIG. 4 is a flow chart showing the process for performing temporal encoding;

FIG. 5 is a three dimensional representation of the spatial and temporal transforms;

FIG. 6 is a system for implementing quality priority encoding within an application specific integrated circuit (ASIC);

FIG. 7 is a block diagram showing a spatial transform module as embodied within an ASIC;

FIG. 8 is a block diagram showing a temporal transform module as embodied within an ASIC;

FIG. 9 is a block diagram showing the quantizer module as embodied within an ASIC;

FIG. 9A is a circuit that is used on the lowest frequency band;

FIG. 9B is a block diagram showing the entropy encoder module as embodied within an ASIC;

FIG. 10 is a flow chart of the steps for quality priority encoding within an ASIC.

### DETAILED DESCRIPTION OF SPECIFIC EMBODIMENTS

Definitions. As used in this description and the accompanying claims, the following terms shall have the meanings indicated, unless the context otherwise requires: the term “information domain” shall refer to a frequency transform domain which when graphically represented has the axes of resolution/energy vs. frequency. It should be understood by one of ordinary skill in the art that frequency may be defined as the rate of change relative to a sample metric (time units, spatial units, angle, etc.) The term “resolution” shall be used in a sampling theory context. As used herein, the terms “resolution” and “quality” shall have the same meaning and in general shall be represented in number of bits or decibels (dBs). It should be understood by one of ordinary skill in the art that digital video data signal may be represented in any one of a variety of formats including V(x,y,t) in which the video signal is composed of a plurality of individual components such as pixels data which have both a spatial and a temporal position. Each pixel may have one or more components to represent the pixel such as an RGB or YUV format in which each pixel has three color components. It should be understood by one of ordinary skill in the art that other formats may have a greater number of color components such as four or more components. Further, pixels may be grouped together into images which will be referred to as frames or video frames. Although the quality priority method and system for implementing the method shall be discussed below with respect to motion video images, such a method may be applied to other data sets such as those of 1 and 2 dimensional image scanners and 3 dimensional medical image scanners for example.

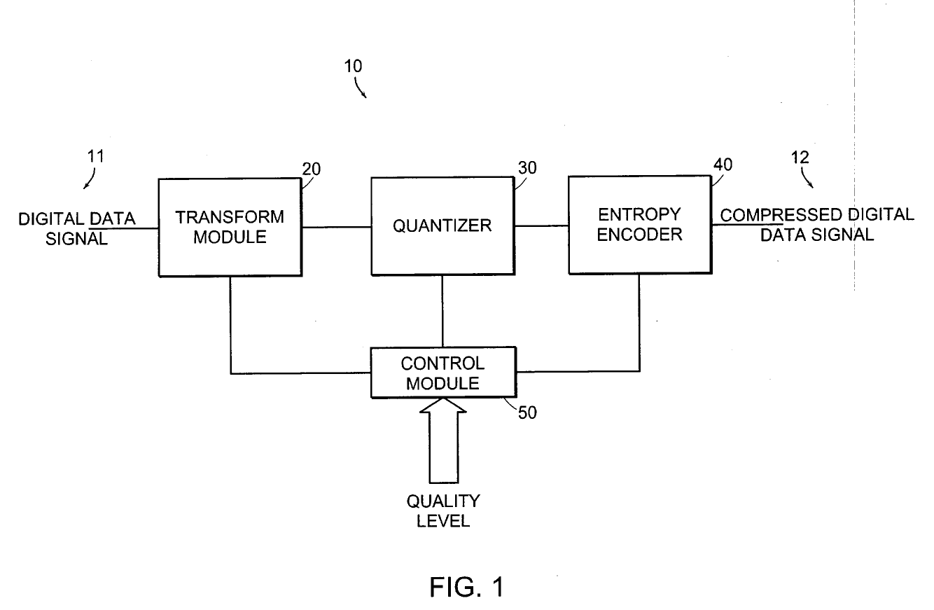

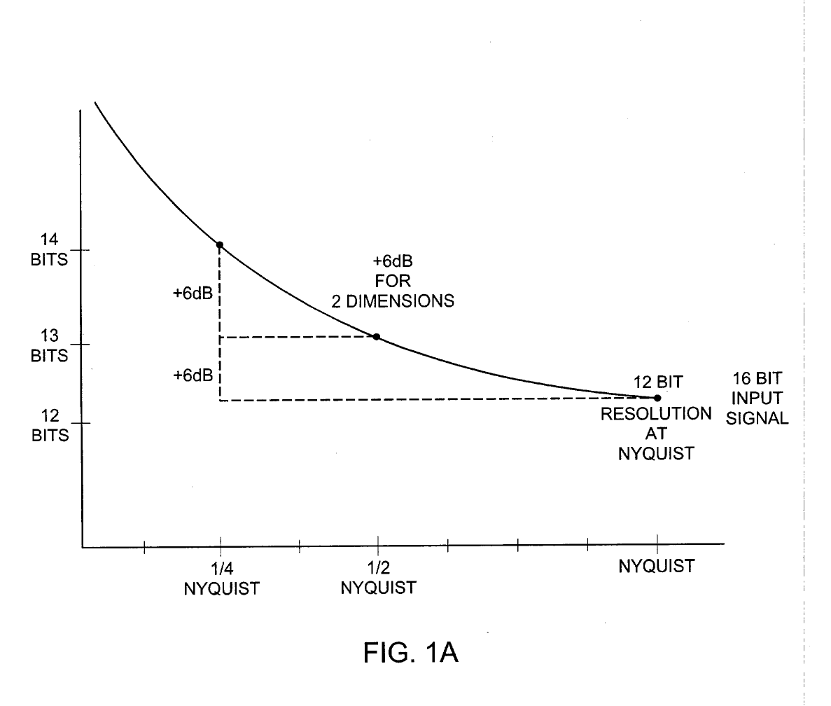

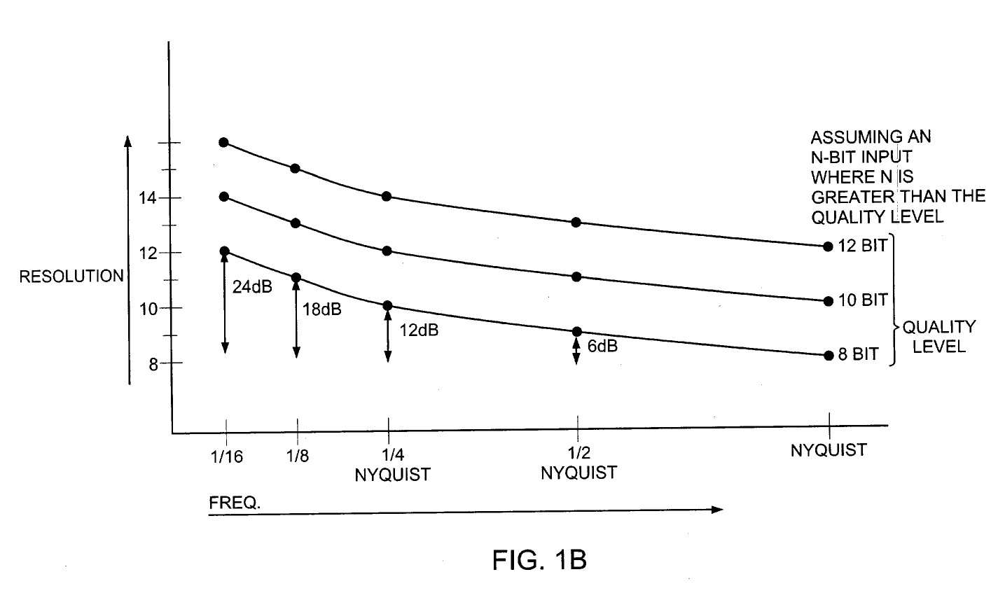

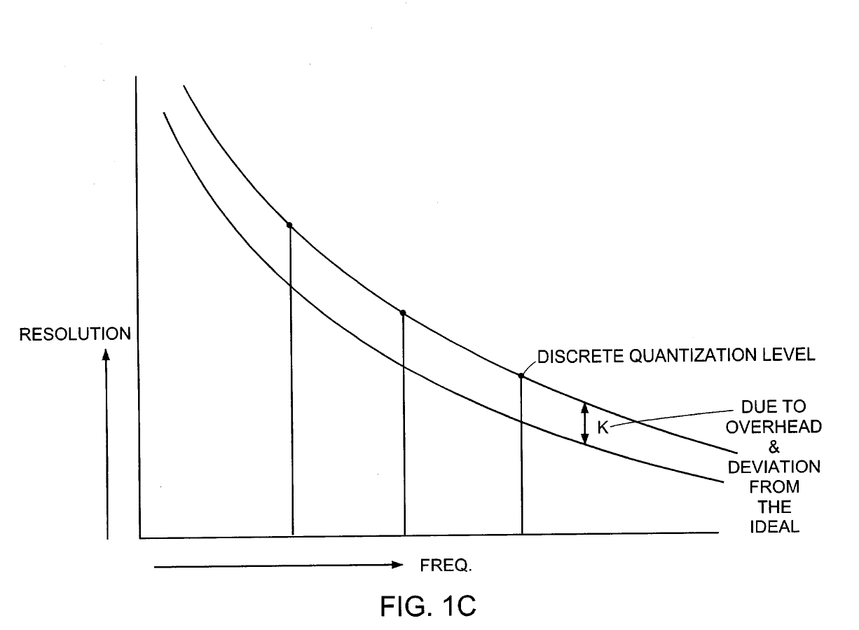

FIG. 1 shows a compression system 10 for removing non-information from a digital data signal 11 while maintaining a defined quality level for the digital data. The digital data signal 11, as well as, the system 10 have a resolution (S/N ratio) which is greater than that of the desired quality level. For example, a 16 bit video input stream v(x,y,t) composed of spatial frames of video which are sequenced in time can be compressed by the 16-bit compression system while maintaining any resolution desired that is below 16 bits. The invention as disclosed and embodied herein is equally applicable to any n-bit system and any n-bit input signal and is not limited by the system capacity or the sample representation of the input signal.

The compression system 10 creates a channel which receives the input data stream 11 and which outputs a compressed version 12 of that sampled digital data stream. Upon decompression, the digital data stream has the desired quality level and the desired quality level is maintained over all component values. For example, if a quality level of 12 bits is requested for resolution at the Nyquist frequency of a 16 bit video input stream, the system would transform the video input stream using a transform such as a wavelet transform. The transformed input stream would then be quantified to preserve the desired resolution and then entropy encoded. In the process, the system would be entropy encoded to compress the video input stream. Upon reversal of this compression process, an output video stream would be produced which would have a resolution that is at least equal to 12 bits in terms of signal to noise.

Such a compression/decompression system may be embodied in hardware or software or a combination thereof. In a preferred embodiment the compression/decompression system is formed in an ASIC (“application specific integrated circuit”) such as that described in provisional patent application No. 60/351,463 entitled “Digital Mastering CODEC ASIC” filed on Jan. 25, 2002 and having the same assignee as the present application or as described in concurrently filed U.S. patent application, entitled “Digital Image Processor” and bearing attorney docket no. 2418/137 which is incorporated herein by reference in its entirety. The compression system 10 as embodied contains three separate modules. The first module is a transformation module 20, the second module is a quantization module 30 and the third module is an entropy encoder module 40. The compression system may also have a fourth module which is a control module 50 which manages the three other modules. The control module 50 could be equipped to receive in a quality level and provide that information to the transformation module 20 and the quantization module 20 wherein the individual modules would perform the requisite mathematical calculations or the control module may be configured to determine the number of possible transforms that may be performed while maintaining the desired quality level and also determine the quantification levels wherein this information would be directed to the transformation module and the quantization module.

Ideally, in order to maintain a desired quality level (resolution) over all frequencies of an input signal, the quantization of data after being transformed by a transform should follow the ideal sampling theory curve as represented in the information domain as shown in FIG. 1A. The curve shows the resolution required to represent the information contained within a signal. The curve has axes of resolution/energy and frequency and is a representation of the localized power spectrum of the input sampled digital data signal. The curve of FIG. 1A assumes a 16 bit original video source signal composed of spatial frames in which 16 bits are used to represent each color of each pixel of a video frame and wherein the desired quality level is twelve bits of information at Nyquist. The curve as shown in FIG. 1A is a for one dimensional representation and it should be understood to one of ordinary skill in the art that this curve may be extended to data signals which are multi-dimensional such that a surface would be needed to represent the transfer function.

As shown in FIG. 1A the required resolution at any frequency in the transformed domain is higher than the original resolution in the sample domain by the ratio of the square root of the ratio of the original Nyquist frequency divided by the frequency of interest. In the case of a multidimensional separable case, the required resolution is the product of the above increase in all dimensions. In a non-separable case, the increase is the square root of the ratio of the distance to the frequency of interest over the distance to the Nyquist frequency.

The curve can be further understood by looking at the effect of noise with respect to an input sampled digital data signal. Nosie, if sampled at less than the Nyquist frequency, will be decorrelated. This decorrelation is frequency dependent. If one were to sample a signal at ½ of the Nyquist frequency, there would be a loss of noise as some of the noise cancels itself which results in a gain of 3 dBs of resolution per dimension. As a result, the number of bits of information needed to represent the resolution of information at lower frequencies, must be substantially greater than that of the number of bits at the Nyquist frequency in order to maintain the same fidelity of the image at DC as that at Nyquist. For each frequency octave down from the Nyquist frequency, an additional 3 dbs of resolution for each dimension of the input data signal are necessary in order to preserve all of the information within the input signal such that S/N ratio can be guaranteed. Expressed in other words, an additional half bit of resolution is necessary due to the decorrelation of noise for each octave down per dimension, such that, a 2-D video image frame would require an additional bit of information per octave. It should be understood by one of ordinary skill in the art that FIG. 1A is only a representative curve and that for each resolution that is desired at a Nyquist frequency for a digital data signal, a different curve exists. This can be shown by FIG. 1B which shows three curves. The first curve is for an 8 bit resolution at Nyquist. The second is for 10 bits of resolution at Nyquist and the third is for 12 bits of resolution at Nyquist.

In practice, such a compression system, when implemented, requires overhead to compensate for non-exact transforms and quantization error. As a result, the discrete quantization levels must lie at some point above the sampling theory curve of FIG. 1A. The overhead which is necessary may be referred to as the k value and is shown in FIG. 1C.

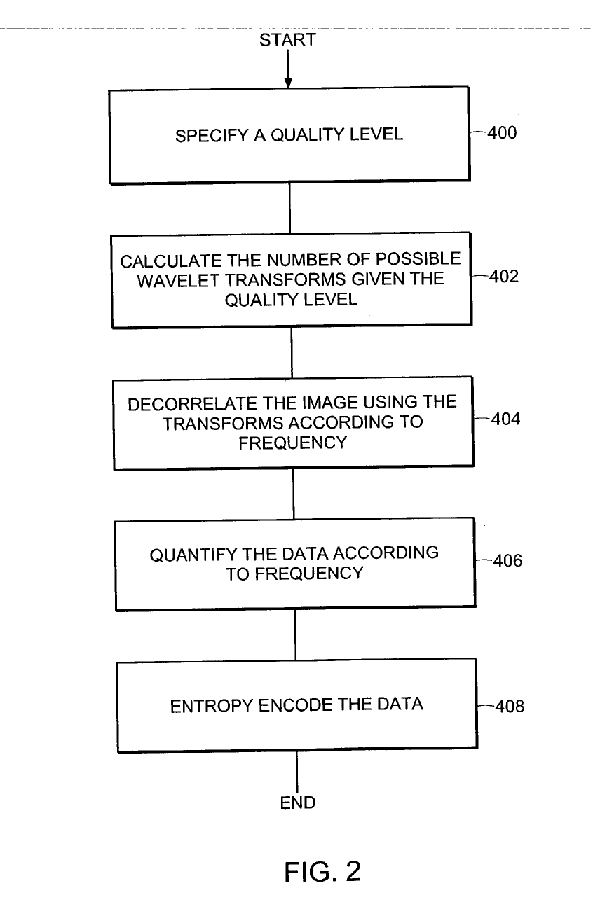

The process for compressing works in the following manner as shown in FIG. 2. First a quality level is chosen, such as a dB level for the compressed output video signal or a signal to noise ratio (Step 400). The quality level is selected by a user of the system. For example, a user may set the resolution/quality level to 12 bits of resolution wherein the input signal was sampled at 16 bits. A calculation is then performed to determine the number of transformations that may be performed in decorrelating the video signal in the transformation module (step 402). For each dimensional transformation, there is a theoretical 3 dB loss in resolution. So a two dimensional transformation will decrease the SNR by 6 db or by 1 bit of resolution. Assuming that there is a 16 bit input video signal, the number of decorrelating transformations is approximately 8. It should be recognized this does not take into account the k value which compensates for the non-ideality of the transforms. The number of transforms can also be stored in a look-up-table in associated memory for the desired signal to noise ratio and the number of bits representing the original video data. This processing step may occur in a global control module of the ASIC chip or may occur off chip in a processor/CPU that controls the chip and loads the modules of the ASIC with processing instructions.

The signal is then transformed from the sample domain to a localized or windowed frequency domain using the number of dimensional transforms (step 404). As such the signal is placed through a sub-band filter which has a number of frequency bands. In one embodiment, the selected transformation is a wavelet transform, but other transforms may be used such as discrete cosine transforms, Haar transforms, and lapped-orthogonal transforms, for example. The transform that is selected preferably will reduce the size of the error bounds k and as a result increase the compression ratio. In order to reduce the error bounds, the selected transform will have one or more of the following properties. The transform may be linear-phase, orthogonal, interpolative and/or perfect reconstruction. These properties assist in the avoidance of frequency abnormalities in the transfer function. Frequency abnormalities cause the transfer function of the wavelet transformation to vary from the ideal response. Thus, without additional compensation during the quantization process, the frequency abnormalities will effect the quality level of the reconstructed signal upon decompression. The greater the frequency abnormalities the greater the need of the transfer function to extends above the ideal flat response and therefore the larger the k error bounds that is needed in order to maintain resolution at all frequencies. Such frequency abnormalities include noise in the system such as quantification noise which results as spikes in the frequency band and frequency edge effects which occur as the result of block based transforms. As such, if a discrete cosine system were to be implemented that employed quality priority, the guard band would need to be much larger than that of a wavelet transform that exhibited, linear phase, orthogonality/biorthogonality, interpolability and exact reconstruction. In such an embodiment employing the discrete cosine transform, the data rate of the signal would need to be increased in order to maintain a quality level over all frequencies to the detriment of the compression ratio.

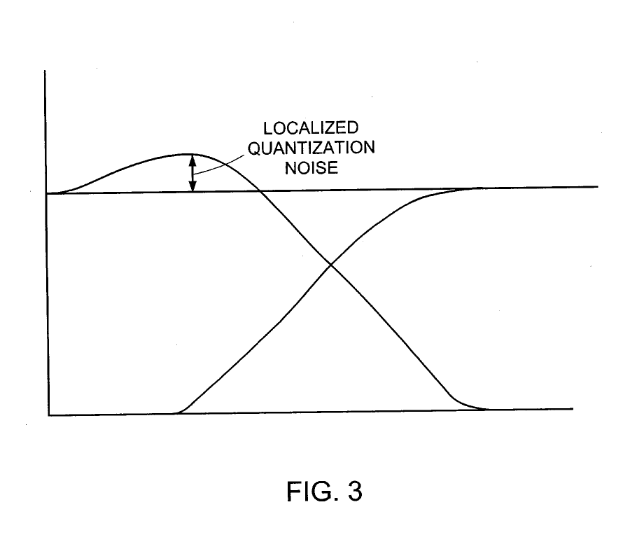

If the transform is non-orthogonal such that the transfer function is not ideally flat, there will be a localization of quantification noise. Such a localization appears as a bump in the transfer function as shown by the lower frequency transfer function of the two-band wavelet pair as shown in FIG. 3. If the transform is non-linear phase the edges of a video image will appear to move upon reconstruction. If the transform is non-interpolative, then the noise within the system will not be evenly distributed in the spatial domain. If the transform is non-perfect reconstruction the inverse transform does not provide the input signal. In the preferred embodiment, the decorrelation transform is a recursively applied wavelet transform. The recursive wavelet transform exhibits the properties of orthogonality, linear phase and the transform is interpolative.

The value of k is determined by the shape of the transfer function and how much it deviates from the ideal sampling theory curve. K is therefore defined by the accuracy of the transforms. The value of k will remain the same over all iterations of the recursively performed wavelet transforms so long as the same wavelet basis function is used. It should be understood by one of ordinary skill in the art that different wavelet functions may be used in the process of creating the transfer function.

Once the transform is performed on the input data set for the calculated number of frequency bands, quantification is performed (Step 406). Quantization is performed according to the continuous sampling theory surface as shown in FIG. 1C which takes into account the non-ideality of the transforms in the form of the guard band k. If the frequency transform yields discrete bands, each band is quantized according to the required resolution of the highest frequency in that band, assuming that lower frequencies within that band will contain the required linearizing noise from the original image.

After quantization, the quantified values are then entropy encoded in order to reduce the number of bits of information (Step 408). An entropy encoder such as that of U.S. Pat. No. 6,298,160, entitled “Apparatus and Method for Entropy Encoding” may be used and the patent is hereby incorporated by reference in its entirety. It should be noted that the entropy encoding step is not necessary for quality priority encoding. The entropy encoding step provides compression of the video image stream. The entropy encoder takes advantage of the fact that there are strings of zero values within the transformed and quantized video image stream. By locating strings of zeros, these zero values can be compressed into a single value that represents the total number of zeros. The entropy encoder also performs entropy encoding by determining a characteristic of the digital video stream local to the value to be encoded and uses this characteristic, which in one embodiment is a weighted average of the recently received digital image values, to select a probability distribution function in a look-up table. Based upon the selected probability distribution function, a probability can be associated with the value to be encoded. Once a probability is determined, entropy encoding, such as Huffman encoding is employed.

It should be noted that the methodology is scalable. If for example the frequency range of the original signal is doubled (Nyquist Frequency double) only an approximately 13 percent increase in data size occurs for a given quality level. If the quality level is increased by 6 dBs and the frequency range of the original signal is doubled there is only an approximately 2.25 times increase in the overall data size.

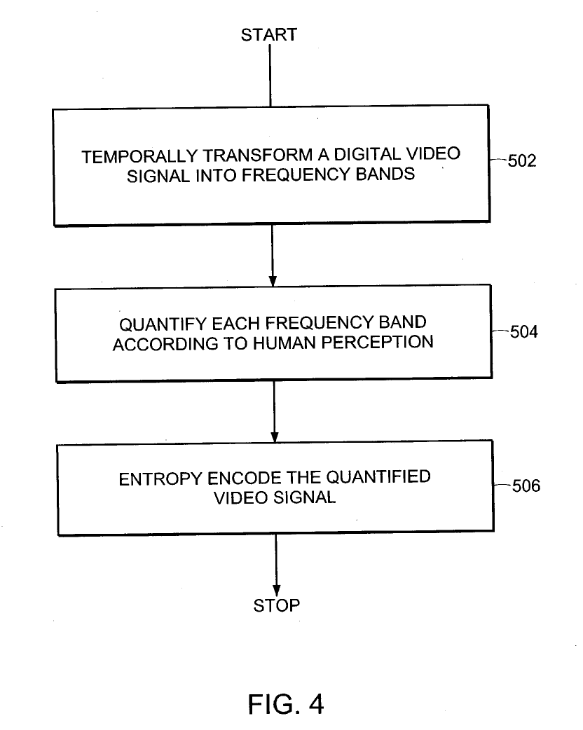

The method and system for guaranteeing quality may be extended beyond 2-dimensional spatial images and may encompass a temporal component such that observable quality is being preserved in a 3-dimensional space. FIG. 4 is a flow chart showing the process for performing temporal encoding. Temporal encoding is similar to spatial encoding such that the input digital signal is transform coded, quantified and then entropy encoded. For temporal encoding of a digital video signal, a transformation is performed with respect to time (Step 502). A wavelet transform or other transform such as a lapped orthogonal transform might be used. The transform looks for correlation with respect to time and requires that multiple frames of video are stored prior to processing. For example, the transform may be an FIR filter that operates on time-aligned samples across a sliding window of temporal image frames. The transformation in the temporal domain is preferably chosen such that it readily handles discontinuities. Once the digital video signal is transformed into a frequency based representation which is divided by sub-bands, the signal may be quantized (Step 504). As with the spatial encoding which was previously described, the temporally transformed data is quantized according to sampling theory. The same sampling theory curve as before may be used, such that lower frequency data values are quantified with more bits in order to preserve the desired resolution. It should be understood that, the sampling theory curve approaches infinity as the signal approaches DC, however for all practical systems in which there are not an infinite number of quantizable frequencies the frequencies can be appropriately quantized so as to match or exceed the sampling theory curve.

In an alternative embodiment, the temporally encoded data is quantized in a manner different from that of the spatial encoding. In such an embodiment, the temporal quantization is based upon human perception. The quantization is done discretely by sub-band wherein the frequency response which is used for a given sub-band is determined through experimentation. The process of determining the transfer function/frequency response is accomplished empirically. A sampling of viewers view a video sequence in which the sequence is quantized with either an increase in quantification within a given sub-band, a decrease in quantization in a sub-band or a complete removal of the frequency or range of frequencies. By running multiple testings, an optimized curve can be defined such that the transfer function is based upon human perception. Based upon this transfer function, the data is appropriately quantified with the requisite number of bits. Once the transformed data is quantified, the digital data may be entropy encoded (Step 504).

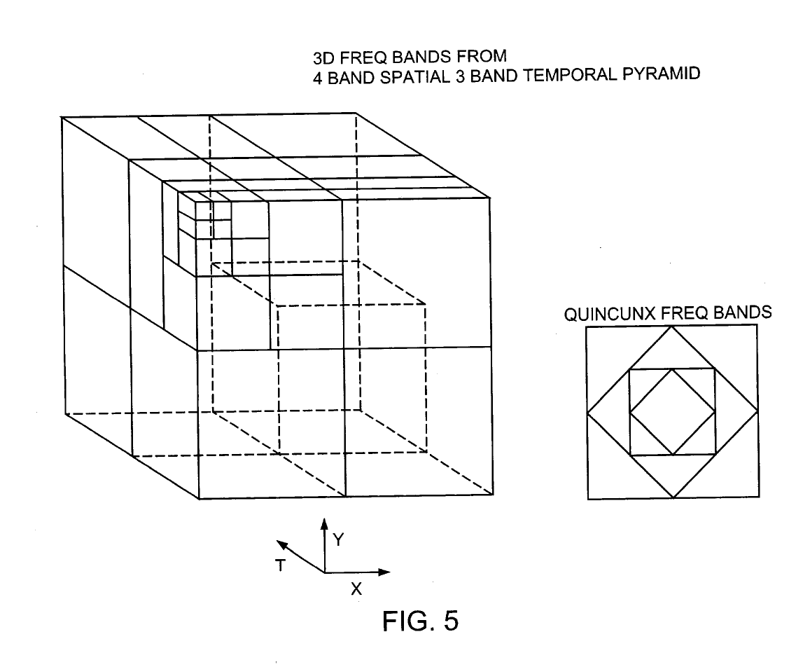

In either embodiment, both spatial and temporal encoding may be combined wherein the spatial encoding component is quantified according to the sampling theory curve while the temporal component is quantified either according to human perception or sampling theory since the spatial and temporal components are separable due to the variables that are used for the transform. A systematical series of pyramid sub-band filters is performed in both the spatial and the temporal domains as shown in FIG. 5 which is a three dimensional frequency mapping wherein there is a 4 band spatial split and a 3 band temporal split. The three dimensional axes are the X,Y and time frequencies. The lowest frequencies are present in the upper left hand corner. The band splitting is performed in the following matter. For example the initial function F(x,y,t) is spatially transformed and bandsplit T(ωₓ₁,ω_{y1},kₜ), T(ωₓ₂,ω_{y2},kₜ) wherein the temporal component is a constant. Then a temporal transform is performed T(kₓ,k_{y},ωₜ) wherein the spatial components are constants. Transforms are then performed in a modified pyramid between the spatial and temporal domains. The frequency components may then be quantized according to the sampling theory curve, wherein the number of bits associated with either the highest frequency (lowest bit number) or the lowest frequency (highest bit number) within the band may be used for quantization. In other embodiments, the number of bits used for quantization may be variable within the band in accordance with the sampling theory curve. Quantization may also be done to the temporal components of the data set. The temporal components are quantified within their band according to either human perception or sampling theory. As such a temporal gain in overall size may be on the order of 6:1 over pure spatial compression.

In other embodiments quality priority may be performed on 4 dimensional data sets and the ASIC chip may receive this multi-dimensional data and process it. One example of a 4 dimensional data set is a 3-D medical diagnostic video such as a sequence of Nuclear Magnetic Resonance (NMR) images that are taken over time. In such an embodiment, a 3-D spatial wavelet transformation is performed and a temporal transform is also performed in sequence which may be either full transforms or pyramid style transforms.

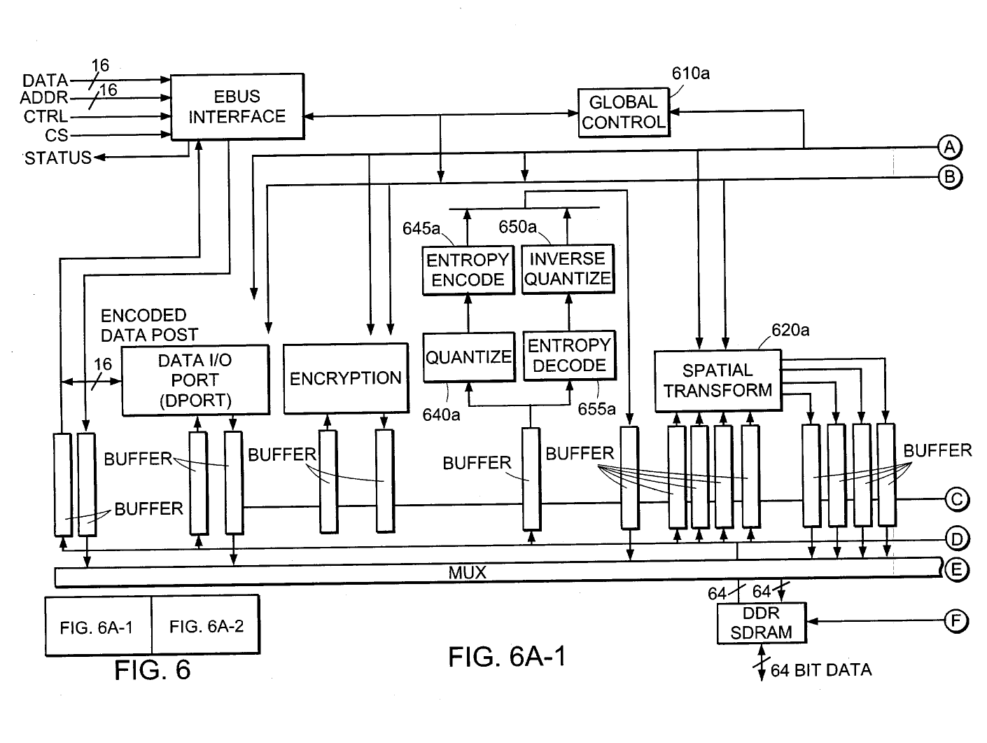

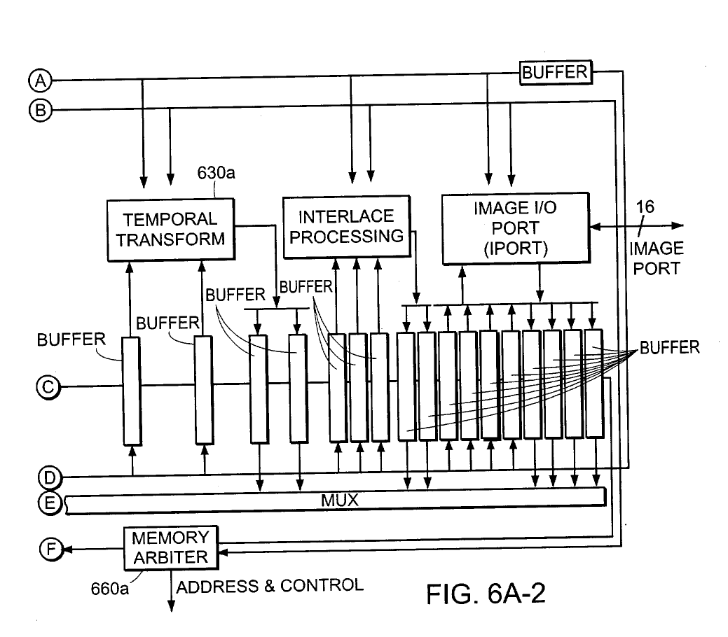

Quality priority encoding may be implemented in an application specific integrated circuit (ASIC) as shown in FIG. 6. In this embodiment, the temporal and spatial transforms are each independently performed in individual modules. Upon start-up each module is provided with instruction which are passed from an external processor such as a CPU (not shown). Each module operates independently and sequencing is provided via a global control module 610A which also passes the instructions to the individual modules. In this ASIC design, spatial encoding is performed in the spatial transform module 620A and temporal encoding is performed in the temporal transform module 630A. Further, there are both quantization and entropy encoding modules 640A, 645A as well as entropy decoding and reverse quantization modules 650A, 655A present. In an embodiment in which the compression system is embodied on an ASIC, the coefficients of the filters which are representative of the transforms in the transformation modules (spatial and temporal) are reprogrammable via the CPU.

As shown in the figure, each module operates independently of the other modules and includes an input and output buffer. All buffers are managed by a sequencer contained within each module. The memory bus arbiter 660A allocates memory bandwidth to each buffer according to its priority and the buffers only send write requests to the memory arbiter. The global control unit 610A enforces synchronization among the different modules having a multiple-bit flag register which may be read and written to by each of the modules. The modules read the flag register and scan the bits for a trigger value. If the trigger value is present within the bits the module begins processing data. Until the trigger is present in the flag registers, the module remains in a wait state. When a module has completed execution of its processes, based upon the code that was received from the CPU writes to the flag registers. The flag registers that are set by a first module are the trigger values for a second module. The trigger values are set within the code that is passed to the modules. In such a way, the computer code controls which modules will be made active and in what sequence. For example the spatial transform module may be made active by a trigger bit and in turn it sets the trigger bit for the quantization/entropy encoder. Thus spatial compression is achieved. In another example, the spatial transform module after execution, may set the trigger value for the temporal transform module which in turn sets the trigger value for the quantizer/entropy encoder module. In this example both spatial and temporal compression occur.

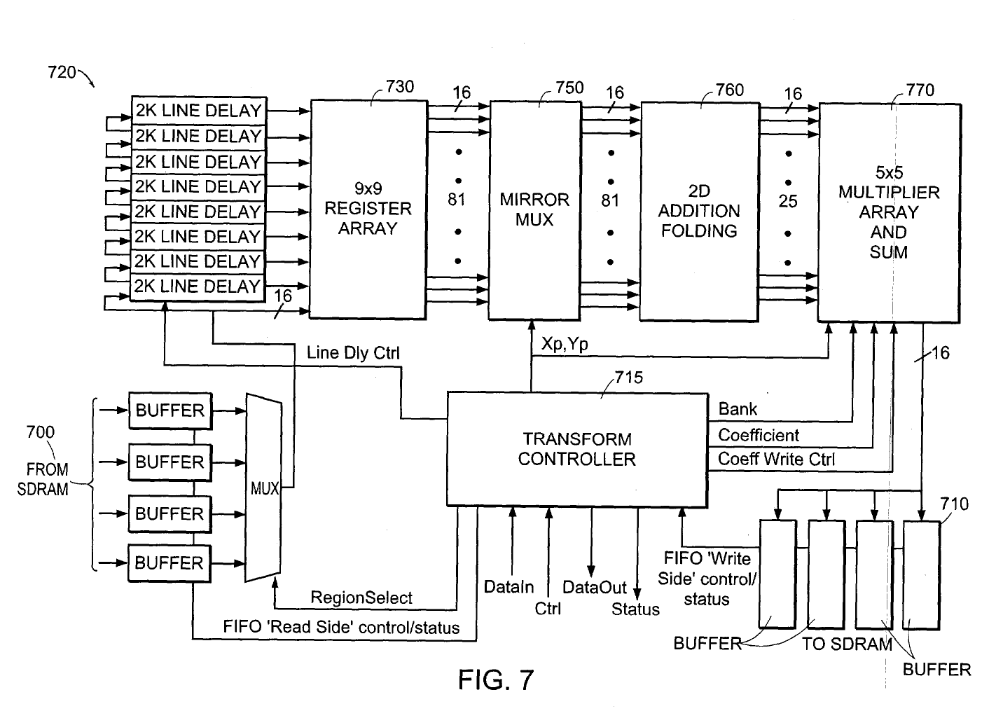

The spatial transform module is designed around a two-dimensional convolution engine. In the embodiment shown in FIG. 7 the convolver is a 9×9 2D matrix filter. In this embodiment the convolver possesses both horizontal and vertical symmetry such that only a 5×5 matrix of multiplers are necessary. The symmetry is such that 16 taps fold 4 times, 8 taps fold 2 times and the center tap has no folding. The spatial transform may be invoked recursively within the spatial transform module through the transform controller.

The spatial transform module has four working buffers 700 and four result buffers 710. Data from the working buffers 700 is selected via the transform controller 715 and passed to eight 2 k deep line delays 720. The eight 2K line delays 720 along with the 9^{th} input line from memory 730 are used to buffer the data going to the convolver. The outputs of the line delays are connected to the convolver 740 and to the input of the next line delay so that the lines advance vertically to effectively advance the position of the convolver within the image. These line delays coupled with the register array 745 present the convolver with an orthognonal data window that slides across the input data set. Boundary conditions exist whereby some of the convolver's inputs do not reside over the top of the image or the region locations do not contain valid data. In the cases where the convolver does not completely overlay valid data, the missing data points are created by mirroring data about the horizontal and vertical axis of the convlover as necessary. For example, at the upper left corner of the image, the center tap along with the lower right quadrant of the convolver overlays valid data while the other three quadrants lack valid data. In such as situation, the transform controller 715 causes the mirroring multiplexer 750 to mirror the data from the lower right quadrant into the other three quadrants for processing. As the convolver processes the image stream data for an image the convolver goes through 81 unique modes. Each of these modes requires a slightly different mirroring. A mirroring multiplexer 750 supports mirroring of valid data over convolver taps that are outside the range of valid data. From the mirror multiplexer 750 which has created the appropriate 81 data values for the calculation of a transformed value for that of the center tap, the data is passed to the 2D addition folding module 760. The 2D folding module 760 imports the 25 values that are necessary for the folded convolver. The 25 values are passed to the 5×5 multiplexer array 770 which performs the multiplication of the data values with the coefficient values of the filter to determine the transformed value for the data that was at the center tap. When the transformed data is determined it is passed to the result buffers 710. The transform controller utilizes the received destination instructions from the external central processing unit and controls the writing of the resultant data to the result buffers.

In the decoding of the encoded digital image signal the process is reversed. For example the signal will be entropy decoded such that the probability associated with the value in the digital data stream is determined through a look-up table. Once the probability is determined a value that is a characteristic of the digital data stream is calculated and a look-up table is accessed to selected an appropriately shaped probability distribution function. From the probability distribution function and the probability, the original value can be determined.

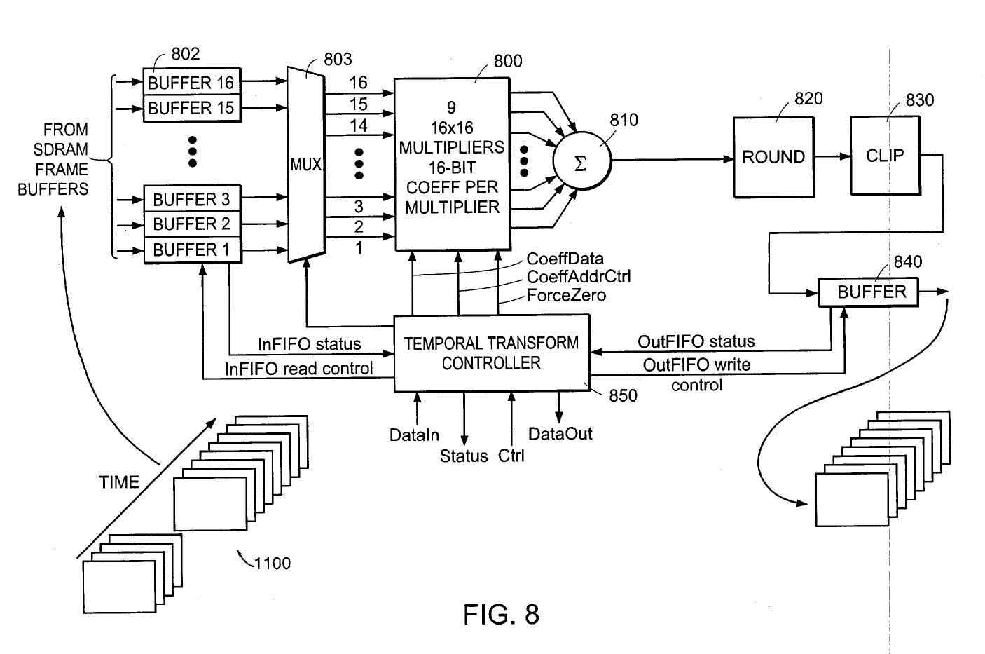

The temporal transform module includes a 9 tap FIR filter that operates on time-aligned samples across asliding window of nine temporal image frames as shown in FIG. 8. The temporal transform module processes multiple frames at a time and produces multiple output frames. Rather than determining values on a frame by frame basis, values for multiple frames are determined at the same time. This provides conservation in memory bandwidth so that data does not have to be read and written to memory on multiple occasions. The implementation requires 16 input frames to produce 8 frames of output, but decreases memory bandwidth. 16 memory buffers 802 feed a multiplexor 803 that routes the frames to one of nine multipliers 800 of the filter. Each multipler 800 has local 16-bit coefficients. The output of the 17 multiplers are summed in summer 810. The values are scaled and rounded in rounder 820 and clipped in clipping module 830. The output of the clipping module is routed to a memory output buffer 840 that produces eight output frames from the 16 input frames. The rounding and clipping operation in the round module and the clipping module are performed to transform the values to an appropriate bit size, such as 16-bit, two's compliment value range. The temporal transform controller 850, provides the coefficient values for the filter, as well as the addresses of the coefficients within the 9tap filter. At the beginning of the digital image stream and at the end of the digital image stream, the temporal transform module mirror image-frames around the center tap of the filter. The mirroring is controlled by the temporal transform controller. Input frames are mirrored by pointing two symmetrically located frame buffers to the same frame.

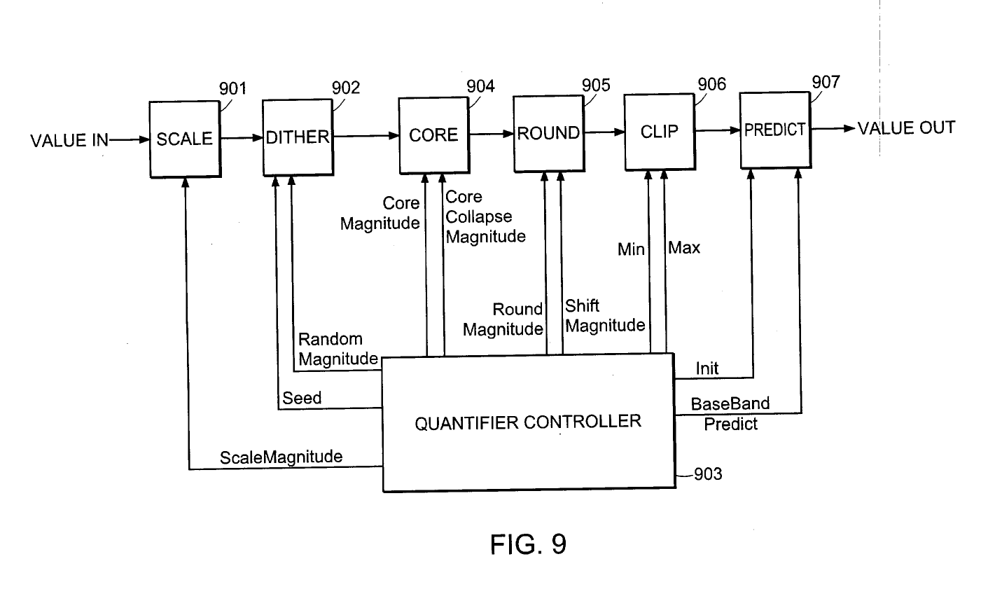

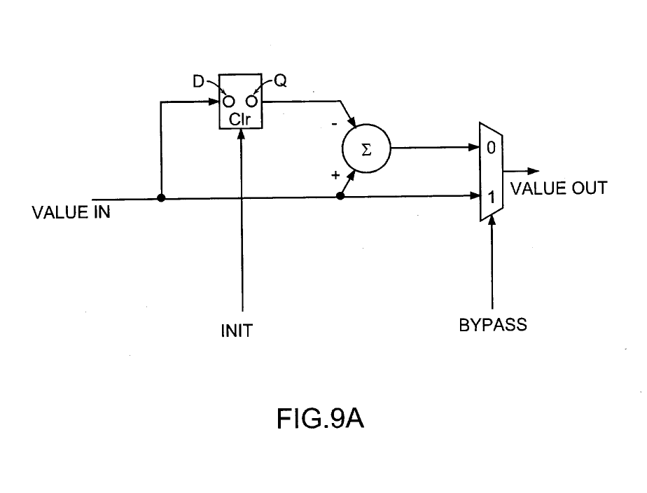

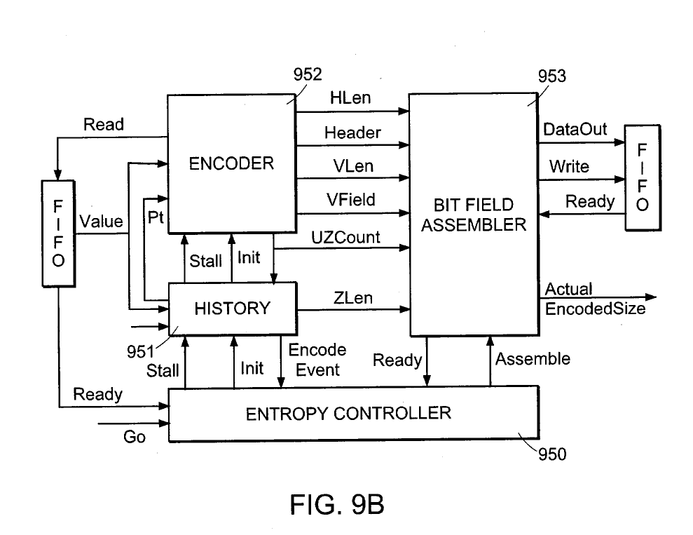

The entropy encoder module includes both a quantizer and an entropy encoder. During encoding the quantization process occurs before entropy encoding and thus the quantizer will be explained first as shown in FIG. 9 The quantification process is performed in the following manner. A value is passed into the quantizer 900. The quantizer may be configured in many different ways such that one or more of the following modules is bypassed. The description of the quantizer should in no way limit the scope of the claimed invention.

The value is first scaled in a scaling module 901. In one embodiment, the scale function of the scaling module 901 multiples the value by a scale magnitude. This scale magnitude allows for the electronic circuit to operate at full precision and reduces the input value to the required signal to noise ratio. Each value is assumed to have passed through either the spatial or the temporal transform modules. As such, the image is broken up into various frequency bands. The frequency bands that are closer to DC are quantized with more bits of information so that values that enter the scaling module 901 that are from a frequency band that is close to DC, as opposed to a high frequency band, are quantized with more bits of information. Each value that is scaled will be scaled such that the value has the appropriate quantization, but also is of a fixed length. The scaled value is then dithered. A seed value and a random magnitude are passed to the dither module 902 from the quantifier controller 903. The dithered value is linearized for quantification purposes as is known in the art. The signal is then sent to a core block 904. The core block 904 employs a coring magnitude value as a threshold which is compared to the scaled value and which forces scaled values that are near zero to zero. The coring magnitude is passed to the core block 904 from the quantifier controller 903. If a field value called collapsing core magnitude is passed, this value represents a threshold for setting values to zero, but is also subtracted from the values that are not equal to zero. The system may also bypass the coreing function and pass the scaled value through. The scaled data value is passed to a rounding module 905 where values may be rounded up or down. The data is then passed to a clip module 906. The clip module 906 receives a max and min value from the quantifier controller 903. The clip module 906 then forces values to the max value that are above the min. value. The signal is then sent to a predict block 907. The baseband prediction module 907 is a special-case quantizer process for the data that is in the last band of the spatial transform output (values closest to DC frequency). The baseband predictor “whitens” the low frequency values in the last band using the circuit shown in FIG. 9A

The entropy encoder module is shown in FIG. 9B. The entropy encoder module is a loss-less encoder which encodes fixed-bit words length image data into a set of variable-bit width symbols. The encoder assigns the most frequently occurring data values minimal bit length symbols while less-likely occurring values are assigned increasing bit-length symbols. Since spatial encoding, which is wavelet encoding in the preferred implementation, and the quantification module tend to produce large runs of zero values, the entropy encoder 950 takes advantage of this situation by run-length encoding the values into a single compact representation. The entropy encoder includes three major data processing blocks: a history/preprocessor 951, encoder 952, and bit field assembler 953. Data in the history block 951 is in an unencoded state while data in the encoder and bit field assembler 953 is encoded data. The encoder 952 performs the actual entropy based encoding of the data into variable bit-length symbols.

The history/preprocessor block 951 stores recent values. For example, the history block may store the four previous values, or the six previous values and the history block 951 may store N previous values. The values are then average weighted and this value is passed to the encoder module 952 along with the most recent value. The encoder module 952 then selects a probability distribution function by accessing a look-up tabled based upon the weighted average. The most recent value is then inserted into the probability distribution function to determine a probability. Once a probability is determined, a variable-length value is associated with the probability by accessing a look-up table. The bit field assembler 953 receives the variable length data words and combines the variable length data words and appends header information.

The header may be identified by subsequent modules, since the header is in a specific format. For example, the sequence may be a set number of 1 values followed by a zero value to indicate the start of the header. The header length is determined by the length of the quantized values which is in turn dependent on the probability of the data word. The header length in conjunction with a length table determines the number of bits to be allocated to the value field. An example of such a look-up table is shown in FIG. 8C.

The uuencoded zero count field contains a value representing the number of zeros that should be inserted in to the data stream. This field may or may not be present and depends on the image data stream that is provided from the quantizer. If there is a predetermined number of zero values that follow a value in the data stream, the zero values can be compressed and expressed as a single value which represents the number of zero values that are present consecutively. As was previously stated, both the quantizer module and the spatial and temporal encoder module will cause the transformed digital image stream to have long stretches of zero values. As such, when multiple zeros are observed within the digital image stream, an unencoded zero count field is added by the encoder 952.

The bit field assembler 953 waits for the header, value field and unencoded zero count field before outputting any data. The bit field assembler 953 has a buffer for storing the maximum size of all three fields. The bit field assembler 953 assembles the data into the output format for the entropy encoder.

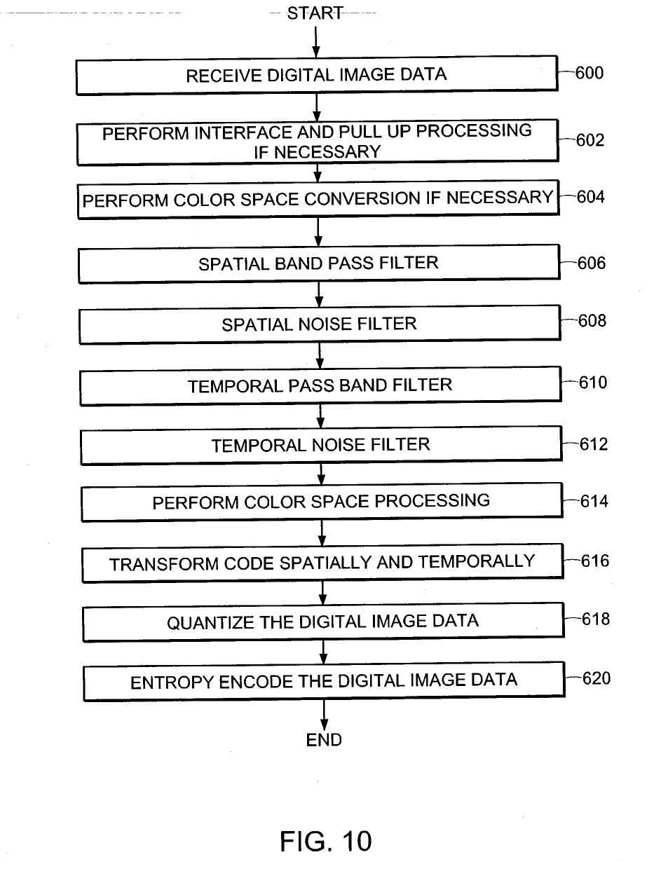

In one embodiment of the system, the system can be configured to perform the following steps as shown in FIG. 10 for encoding. First digital image data is received as an input (Step 600). Interlace and pull up processing would be performed if needed on the digital image data (Step 602). For example, if the image was film originating (24 frames per second), the system might separate the frame into fields and perform a 3:2 pull down on the digital image data so that it could be displayed at 60 fields per second. Similarly the signal may be color space converted (Step 604). For example the color space may be initially RGB and it could be converted to YUV depending on what is desired at the output. Further, the image may go through up conversion or down conversion such that the size of the image is either increased or decreased. The digital image data is then passed through a control loop. First the signal is spatially pass band filtered such that each frame of video is separated into separate sub-bands (Step 606). Noise is then filtered by passing each of the sub-bands through a spatial noise filter (Step 608). The filter may be designed to pass all frequencies below the Nyquist frequency, for example. The signal is then temporally pass band filtered (Step 610). The signal is divided into sub-bands in which time is the variable and position is fixed. The signal is then passed through a noise filter to remove excess noise (Step 612). Color space processing is then performed (Step 614). The signal is now ready to be transform coded both with a 2-D spatial transform and a temporal transform (Step 616). The spatial transform may be any transform which decorrelates the signal thereby removing noise. As stated above, the transform is preferable a wavelet transform. Temporally, the transform may be a Haar transform, but preferably a transform that readily accommodates discontinuities. The signal is then passed through a non-linear remapping for the quantization process as described above (618). The signal can then be entropy encoded (620).

It should be understood by one of ordinary skill in the art, that each module has been described with respect to the encoding process, but that each module could be programmed through program code to decode a digital data stream back into a digital image stream.

Further, it should be understood that the resultant digital data stream may be output and stored on a medium, such as a CD-ROM or DVD-ROM for later decompression using the above described ASIC for decoding or decompressed in a software version of the ASIC that operates in a decoding mode.

In an alternative embodiment, part of the disclosed invention may be implemented as a computer program product for use with the electronic circuit and a computer system. It should be recognized that the electronic circuit may receive computer instructions for performing the above described methodology. The instructions may be passed to the electronic circuit through a central processing unit that is electrically coupled to the electronic circuit. The instructions may be stored in memory associated with the electronic circuit and the instructions executed by the electronic circuit.

Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Further the digital data stream may be stored and maintained on a computer readable medium and the digital data stream may be transmitted and maintained on a carrier wave.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A method for compressing a digital data signal while maintaining a quality level, the method comprising:
receiving a signal representative of a quality level;
decorrelating the digital data signal based in part on the received quality level;
quantifying the decorrelated digital data signal according to frequency so as to provide equal resolution across all frequencies; and
entropy encoding the quantified digital data signal.

2. The method according to claim 1, wherein decorrelating includes calculating a number of transforms to be performed on the digital data signal while still maintaining the quality level.

3. A method for compressing a digital data signal comprising:
temporal transform coding the digital data signal so as to decorrelate the digital data signal according to time;
quantifying the temporally transformed digital data signal to maintain a desired resolution across all frequencies; and
entropy encoding the temporally transformed digital data signal.

4. The method according to claim 3, wherein quantifying follows a transfer function for each sub-band region.

5. The method according to claim 4, wherein the transfer function is empirically determined.

6. A method for compressing a digital data signal while maintaining a quality level, the method comprising:
receiving a selected resolution;
determining a number of frequency band splits dependent in part on the selected resolution;
transforming the digital data signal into a frequency representation having the number of frequency bands;
for each frequency band, determining a data size for representing the selected resolution; and
entropy encoding the quantified digital data signal.

16. The method according to claim 15, further comprises:
calculating a transform number based in part on the quality level, wherein the transform number is the number of transforms that can be performed to decorrelate the data signal given the quality level.

17. The method according to claim 16, dividing the digital data signal by frequency.

18. The method according to claim 16, wherein the transforms are wavelet transforms.

19. The method according to claim 15 wherein the quality level is specified in number of bits of resolution.

20. The method according to claim 15 wherein the quality level is specified as an error threshold.

21. The method according to claim 15 wherein the data signal is representative of video images.

22. The method according to claim 15 wherein the data signal is representative of audio.

23. The method according to claim 15 wherein the data signal is representative of video images and audio.

24. The method according to claim 1, wherein the transfer function is based upon sampling theory.

25. An electronic chip for compressing digital data so as to maintain a quality level upon decompression, the electronic chip comprising:
a quality priority module.

26. The electronic chip according to claim 25, wherein the quality priority module includes a transform coder circuit for transform coding the digital data.

27. The electronic chip according to claim 26, wherein the quality priority module includes a quantization module that assign quantization values so that the resolution of the digital data is varied.

28. The electronic chip according to claim 27, wherein the quality priority module includes an entropy encoder module for entropy encoding the quantized digital data.

29. The electronic chip according to claim 27, wherein the transform coder module divides the digital data into frequency bands and wherein the quantization module quantizes the frequency bands with varying sizes.

30. The electronic chip according to claim 28, wherein the quantization module quantizes the frequency bands based upon a sampling theory curve.

31. The electronic chip according to claim 29, wherein the sampling theory curve is determined based upon the desired quality level and the frequency spectrum of the digital data.

32. The electronic chip according to claim 29 wherein the transform coder circuit is programmed to perform a wavelet-based transform.

33. The electronic chip according to claim 29, wherein the transform coder circuit is programmable through electronic instructions.

34. The electronic chip according to claim 29 wherein the transform coder circuit performs spatial-based wavelet encoding.

35. The electronic chip according to claim 29 wherein the transform coder circuit perform temporal-based wavelet encoding.

36. The electronic chip according to claim 29 wherein the transform coder circuit performs both temporal and spatial wavelet based encoding.

37. An electronic chip for compressing a digital data signal while maintaining a quality level, the electronic chip comprising:
means for receiving a signal representative of a quality level;
means for decorrelating the digital data signal based in part on the received quality level;
means for quantifying the decorrelated digital data signal according to frequency so as to provide equal resolution across all frequencies; and
means for entropy encoding the quantified digital data signal.

38. The electronic chip according to claim 37, wherein the decorrelating means includes means for calculating a number of transforms to be performed on the digital data signal while still maintaining the quality level.

39. An electronic chip for compressing a digital data signal comprising:
means for temporal transform coding the digital data signal so as to decorrelate the digital data signal according to time;
means for quantifying the temporally transformed digital data signal to maintain a desired resolution across all frequencies; and
means for entropy encoding the temporally transformed digital data signal.

40. The electronic chip according to claim 39, wherein the means for quantifying quantifies each frequency band following a transfer function.

41. The electronic chip according to claim 41, wherein the transfer function is contained within electronic code that operates with the electronic chip.

42. An electronic chip for compressing a digital data signal while maintaining a quality level, the electronic chip comprising:
means for receiving a selected resolution;
means for determining a number of frequency band splits dependent in part on the selected resolution;
means for transforming the digital data signal into a frequency representation having the number of frequency bands;
means for determining a data size for representing the selected resolution for each frequency band;
means for quantifying the transformed digital data signal based upon the determined data size for each frequency band; and
means for entropy encoding the transformed digital data signal.
